(19) United States
(12) Patent Application Publication
(10) Pub. No.: US 2017/0300459 A1
(43) Pub. Date: Oct. 19, 2017

(54) CARD-TYPE DESKTOP IMPLEMENTATION METHOD AND APPARATUS

(71) Applicant: ALIBABA GROUP HOLDING LIMITED, George Town (KY)

(72) Inventors: Zirong LUO, Hangzhou (CN); Peikai ZHANG, Hangzhou (CN); Zixu ZHAO, Hangzhou (CN); Ruihua WEI, Hangzhou (CN); Chao HUA, Hangzhou (CN)

(73) Assignee: ALIBABA GROUP HOLDING LIMITED

(21) Appl. No.: 15/639,578

(22) Filed: Jun. 30, 2017

Related U.S. Application Data
(63) Continuation of application No. PCT/CN2015/098257, filed on Dec. 22, 2015.

(30) Foreign Application Priority Data
Dec. 31, 2014 (CN) 201410849927.2

(51) Int. Cl. G06F 17/21; G06F 9/44; G06F 3/0481

(52) U.S. Cl. CPC G06F 17/212; G06F 9/4443; G06F 3/0481

(57) ABSTRACT

The present invention provides card-type desktop implementation methods and apparatuses. One method embodiment includes: providing, by a desktop module, a resource address corresponding to a service card for a rendering module; rendering, if an application cache has included a resource file corresponding to the resource address, the resource file to a view corresponding to the service card; otherwise, acquiring, from a server, the resource file corresponding to the resource address, rendering the acquired resource file to the view, and storing the acquired resource file into the application cache. The embodiments of the present invention gets rid of template restrictions and reduces system consumption. A resource file used in rendering is cached using an application cache, and the resource file in the application cache may be used for rendering, thus saving network resources. Further, a service card can be displayed normally without internet.

### CROSS REFERENCE TO RELATED APPLICATION

This application claims priority to International Application No. PCT/CN2015/098257, filed on Dec. 22, 2015, which claims priority to and the benefits of priority to Chinese Application No. 201410849927.2, filed on Dec. 31, 2014, both of which are incorporated herein by reference in their entireties.

### TECHNICAL FIELD

The embodiments of the present disclosure relate to the field of computer application technologies, and in particular, to card-type desktop implementation methods and apparatuses.

### BACKGROUND

With the popularization and development of mobile terminals, the mobile terminals have not only been a tool for users to conduct communication, but also gradually become an important means of acquiring information. For example, many mobile device users receive information and/or notifications about services. In light of the increasing use of these notifications, a card-type desktop is becoming increasingly popular.

In current implementations of the card-type desktop, a desktop process uses a desktop area as a display area of service cards. The desktop process abstracts each service card in advance, to obtain a display template of the service card. After data to be displayed is acquired from a server terminal, the data is filled into the display template, to form a view displayed on the desktop.

This process, however, has a relatively severe problem. For example, it is necessary to abstract service cards with different structures respectively, and define and install different templates. Moreover, when the structure of the data sent by the server terminal changes, it is necessary to define and install templates anew. The installation and subsequent storage of a great number of templates greatly affects the extendibility of the service cards and, and at the same time, brings about relatively great consumption to the system. In addition, each time it is necessary to request data from the server terminal and fill the data into the service card, which wastes network resources, and the service card cannot be displayed normally when there is no connection to the network.

### SUMMARY

In view of this, the embodiments of the present disclosure provide card-type desktop implementation methods and apparatuses, in order that system consumption is reduced, network resources are saved, and a service card can be displayed normally even if there is no connection to the network.

Specific technical solutions are as follows:

Some embodiments of the present disclosure provide a card-type desktop implementation method, the method including:

providing, by a desktop module, a resource address corresponding to a service card for a rendering module;

rendering, if the rendering module determines that an application cache has included a resource file corresponding to the resource address, the resource file corresponding to the resource address in the application cache to a view corresponding to the service card; and

otherwise, acquiring, from a server terminal, the resource file corresponding to the resource address, rendering the acquired resource file to the view corresponding to the service card, and storing the acquired resource file into the application cache.

According to some embodiments of the present disclosure, the providing, by a desktop module, a resource address corresponding to a service card for a rendering module includes:

creating, by the desktop module upon receipt of a resource address provided by a service management module, an available view area on a desktop if a service card corresponding to the resource address has not yet existed, the view area being used to display the service card corresponding to the resource address; creating a view corresponding to the service card in the view area; and sending view information and the resource address to the rendering module.

According to some embodiments of the present disclosure, the desktop module, upon receipt of the resource address provided by the service management module, sends, if a service card corresponding to the resource address has already existed on the desktop, the resource address and view information corresponding to the service card to the rendering module.

According to some embodiments of the present disclosure, the providing, by a desktop module, a resource address corresponding to a service card for a rendering module includes:

reading, by the desktop module after startup, related information of a service card in a database, the related information of a service card including a resource address and view information corresponding to the service card; creating a view on a desktop according to the view information; and sending the resource address and the view information to the rendering module.

According to some embodiments of the present disclosure, the providing, by a desktop module, a resource address corresponding to a service card for a rendering module includes:

acquiring, by the desktop module, an operational event of a user on the service card, and then providing a resource address requested by the operational event for the rendering module.

According to some embodiments of the present disclosure, the acquiring, by the desktop module, an operational event of a user on the service card includes:

reporting the operational event to the desktop module when the rendering module captures the operational event of a user on the service card; or,

reporting the operational event to the desktop module when a JavaScript code on the service card captures the operational event of a user on the service card.

According to some embodiments of the present disclosure, the method further includes:

rendering, after the rendering module captures an operational event of a user on the service card, a resource file corresponding to a resource address requested by the operational event in the application cache to a view corresponding to the service card, if it is determined that the application cache has included the resource file corresponding to the resource address requested by the operational event;

otherwise, acquiring, from the server terminal, the resource file corresponding to the resource address requested by the operational event, rendering the acquired resource file to the view corresponding to the service card, and storing the acquired resource file into the application cache.

According to some embodiments of the present disclosure, the method further includes:

deleting, by the rendering module or the desktop module, resource files corresponding to resource addresses which are not accessed within a preset time in the resource addresses corresponding to the service card, from the application cache, if the number of resource files corresponding to the service card in the application cache exceeds a preset number threshold.

According to some embodiments of the present disclosure, the deleting resource files corresponding to resource addresses from the application cache includes:

sending, by the rendering module, a request to the server terminal by using the resource addresses, the request carrying indication information of deleting a resource file;

analyzing a response returned by the server terminal; and

deleting, if an application cache list carried in the response is empty, the resource files corresponding to the resource addresses in the application cache.

According to some embodiments of the present disclosure, the desktop module, after acquiring the operational event of a user on the service card, creates a window, and provides information of the window for the rendering module; and

the step of rendering the acquired resource file to the view corresponding to the service card includes: rendering, if the rendering module acquires the information of the window, the acquired resource file to the corresponding window according to the information of the window; otherwise, rendering the acquired resource file to the view corresponding to the service card.

According to some embodiments of the present disclosure, the JavaScript code on the service card, when reporting the operational event to the desktop module, further reports size information and/or position information of the window to the desktop module; and

the desktop module performs, according to the size information and/or the position information of the window, the step of creating a window.

Some embodiments of the present disclosure further provide a card-type desktop implementation apparatus, the apparatus including: a desktop module and a rendering module, wherein

the desktop module is configured to: provide a resource address corresponding to a service card for the rendering module; and

the rendering module is configured to: upon receipt of the resource address, render, if it is determined that an application cache has included a resource file corresponding to the resource address, the resource file corresponding to the resource address in the application cache to a view corresponding to the service card; otherwise, acquire, from a server terminal, the resource file corresponding to the resource address, render the acquired resource file to the view corresponding to the service card, and store the acquired resource file into the application cache.

According to some embodiments of the present disclosure, the apparatus further includes: a service management module;

the service management module is configured to: provide a resource address from the server terminal for the desktop module; and

the desktop module is configured to: create, upon receipt of the resource address provided by the service management module, an available view area on a desktop, if a service card corresponding to the resource address has not yet existed, the view area being used to display the service card corresponding to the resource address; create a view corresponding to the service card in the view area; and send view information and the resource address to the rendering module.

According to some embodiments of the present disclosure, the desktop module is further configured to: upon receipt of the resource address provided by the service management module, send, if a service card corresponding to the resource address has already existed on the desktop, the resource address and view information corresponding to the service card to the rendering module.

According to some embodiments of the present disclosure, the desktop module is further configured to: read, after startup, related information of a service card in a database, the related information of a service card including a resource address and view information corresponding to the service card; create a view on a desktop according to the view information; and send the resource address and the view information to the rendering module.

According to some embodiments of the present disclosure, the desktop module is further configured to: acquire an operational event of a user on the service card, and then provide a resource address requested by the operational event for the rendering module.

According to some embodiments of the present disclosure, the rendering module is further configured to: report the operational event to the desktop module when capturing the operational event of a user on the service card; or

report the operational event to the desktop module when a JavaScript code on the service card captures the operational event of a user on the service card.

According to some embodiments of the present disclosure, the rendering module is further configured to:

render, after capturing an operational event of a user on the service card, a resource file corresponding to a resource address requested by the operational event in the application cache to a view corresponding to the service card, if it is determined that the application cache has included the resource file corresponding to the resource address requested by the operational event;

otherwise, acquire, from the server terminal, the resource file corresponding to the resource address requested by the operational event, render the acquired resource file to the view corresponding to the service card, and store the acquired resource file into the application cache.

According to some embodiments of the present disclosure, the rendering module or the desktop module is further configured to: delete resource files corresponding to resource addresses which are not accessed within a preset time in the resource addresses corresponding to the service card, from the application cache, if the number of resource files corresponding to the service card in the application cache exceeds a preset number threshold.

According to some embodiments of the present disclosure, the rendering module, when deleting resource files corresponding to resource addresses from the application cache, is further configured to: send a request to the server terminal by using the resource addresses, the request carrying indication information of deleting a resource file; analyze a response returned by the server terminal; and if an application cache list carried in the response is empty, delete the resource files corresponding to the resource addresses in the application cache.

According to some embodiments of the present disclosure, the desktop module is further configured to: after acquiring the operational event of a user on the service card, create a window, and provide information of the window for the rendering module; and

the rendering module is further configured to: render, when acquiring the information of the window, the acquired resource file to the corresponding window according to the information of the window; otherwise, perform the operation of rendering the acquired resource file to the view corresponding to the service card.

According to some embodiments of the present disclosure, the desktop module is further configured to: receive size information and/or position information of the window reported by the JavaScript code; and perform, according to the size information and/or the position information of the window, the operation of creating a window.

Some embodiments of the present disclosure further provide a card-type desktop implementation method, the method including:

acquiring a resource address corresponding to a service card;

rendering, if an application cache has included a resource file corresponding to the resource address, the file corresponding to the resource address in the application cache to a view corresponding to the service card; and

otherwise, acquiring, from a server terminal, the resource file corresponding to the resource address, rendering the acquired resource file to the view corresponding to the service card, and storing the acquired resource file into the application cache.

According to some embodiments of the present disclosure, the acquiring a resource address corresponding to a service card includes:

creating, after a resource address from the server terminal is received, an available view area on a desktop, if a service card corresponding to the resource address has not yet existed, the view area being used to display the service card corresponding to the resource address, and creating a view corresponding to the service card in the view area.

According to some embodiments of the present disclosure, the method further includes:

after an operational event of a user on the service card is captured, rendering a resource file corresponding to a resource address requested by the operational event in the application cache to a view corresponding to the service card, if it is determined that the application cache has included the resource file corresponding to the resource address requested by the operational event;

otherwise, acquiring, from the server terminal, the resource file corresponding to the resource address requested by the operational event, rendering the acquired resource file to the view corresponding to the service card, and storing the acquired resource file into the application cache.

According to some embodiments of the present disclosure, the method further includes:

deleting resource files corresponding to resource addresses which are not accessed within a preset time in the resource addresses corresponding to the service card, from the application cache, if the number of resource files corresponding to the service card in the application cache exceeds a preset number threshold.

According to some embodiments of the present disclosure, the deleting resource files corresponding to resource addresses from the application cache includes:

sending a request to the server terminal by using the resource addresses, the request carrying indication information of deleting a resource file; and

analyzing a response returned by the server terminal, and if an application cache list carried in the response is empty, deleting the resource files corresponding to the resource addresses in the application cache.

It can be seen from the above technical solutions that the present disclosure implements loading and display of resource content in any form by means of rendering, thus getting rid of template restrictions and reducing system consumption. In addition, a resource file used in rendering is cached by using an application cache, and the resource file in the application cache may be used for rendering, thus saving network resources. Further, a service card can be displayed normally even if there is no network, thus enhancing user experience.

### BRIEF DESCRIPTION OF THE DRAWINGS

FIG. 1 is a structural diagram of an exemplary system architecture, according to some embodiments of the present disclosure;

FIG. 2 is an example diagram of layout of a card-type desktop, according to some embodiments of the present disclosure;

FIG. 3 is a flow chart of an exemplary method, according to some embodiments of the present disclosure;

FIG. 4 is a flow chart of an exemplary method for creating a new card service, according to some embodiments of the present disclosure;

FIG. 5 is a flow chart of an exemplary method for establishing a card service when a mobile terminal is restarted, according to some embodiments of the present disclosure;

FIG. 6 is a first flow chart of an exemplary method for responding to an event of a user interacting with a service card, according to some embodiments of the present disclosure;

FIG. 7 is a flow chart of another exemplary method for responding to an event of a user interacting with a service card, according to some embodiments of the present disclosure;

FIG. 8 is a flow chart of an another exemplary method for responding to an event of a user interacting with a service card, according to some embodiments of the present disclosure;

FIG. 9 is an example diagram of a desktop card, according to some embodiments of the present disclosure;

FIG. 10 is an example diagram of one desktop formed after he desktop card shown in FIG. 9 responds to an operational event of a user, according to some embodiments of the present disclosure; and

FIG. 11 is an example diagram of another desktop formed after the desktop card shown in FIG. 9 responds to an operational event of a user, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the disclosure. Instead, they are merely examples of apparatuses and methods according to some embodiments of the present disclosure, the scope of which is defined by the appended claims.

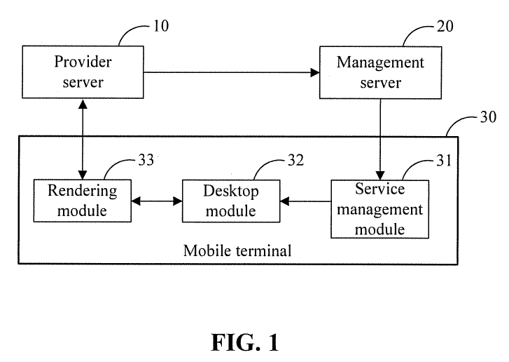

To facilitate understanding about embodiments of the present disclosure, a system architecture on which some embodiments of the present disclosure are based is described. As shown in FIG. 1, the system architecture on which some embodiments of the present disclosure are based may include a provider server 10, a management server 20, and a mobile terminal 30. The provider server 10 may also be independent of the system, that is, the system architecture may include a management server 20 and a mobile terminal 30. In some embodiments, the mobile terminal 30 may include a card-type desktop implementation apparatus.

The card-type desktop implementation apparatus can further include a service management module 31, a desktop module 32, and a rendering module 33.

If a provider needs to push resources to the mobile terminal, such as texts, videos, images, and the like, a corresponding resource address may be sent to management server 20 through provider server 10. The resource address may be a Uniform Resource Locator (URL), and is described as a URL in the subsequent embodiments. Here, management server 20 may only open an interface to a provider server 10, with which the management server 20 cooperates.

After receiving the URL from provider server 10, management server 20 can send the URL to the service management module 31 in the mobile terminal 30. In some embodiments of the present disclosure, if a user of the mobile terminal 30 hopes to obtain a card service of a card-type desktop, the user may register at the management server 20 and subscribe to the card service in advance. In some embodiments, the management server 20 sends a URL corresponding to the card service to the mobile terminal, which registers and subscribes to the card service. For example, a user subscribes to a reading service of a provider, and if the provider sends a URL, the management server 20 sends the URL to the service management module 31 in the mobile terminal 30 associated with the user.

The service management module 31 in the mobile terminal 30 sends the URL to the desktop module 32. The desktop module 32, after acquiring the URL, creates an available view area on a desktop, the view area being used to display a service card corresponding to the URL. Here, the available view area may be a view area not occupied on the desktop, and may also be a view area not occupied within a preset range on the desktop. Then, the desktop module 32 may create, in the view area, a view corresponding to the service card, and provide information of the view and the URL for the rendering module 33. The information of the view may be a handle of the view. That is, the desktop module 32 transmits the handle of the view created to the rendering module 33.

The service management module 31 and the desktop module 32 may be implemented in the form of a process in the mobile terminal 30. For example, the service management module 31 and the desktop module 32 may be embodied as a service management process and a desktop process respectively.

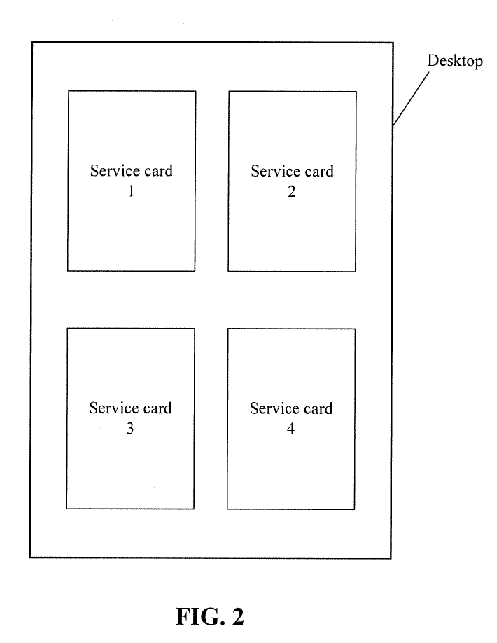

The view area may be created on the desktop according to a preset layout manner of a card-type desktop. For example, the desktop module 32 may create the view area of the service card according to the layout manner shown in FIG. 2. For example if there is a view area not occupied, a resource file of the service card may be rendered into a view in the view area. In the embodiments shown in FIG. 2, there may be at most 4 service cards on the desktop. It is appreciated that, FIG. 2 only shows an example of one layout, and the embodiments of the present disclosure do not limit the layout of the card-type desktop.

The rendering module 33 acquires a corresponding resource file according to the URL provided by the desktop module 32. That is, the rendering module 33 may acquire from the provider server 10 the resource file corresponding to the URL. The resource file may be a HyperText Mark-up Language (HTML) file, but may also be a multimedia file such as a video file or an image. It is appreciated that the multimedia file may also be embedded into the HTML file for implementation.

The rendering module 33, after obtaining the resource file, renders the resource file into the corresponding view according to the information of the view provided by the desktop module 32. In this way, the resource file can be displayed in the view area, and may be shown, on the desktop, as a service card resident on the desktop. In addition, the desktop module 32 may store related information of the service card in a database, such that the mobile terminal 30 can automatically read the related content and display the corresponding service card during startup. The related information of the service card may be URL information and information of the corresponding view. The information of the view may include a handle of the view, position information of the view, and the like. The rendering module 33 may be implemented by means of a web engine.

So far, creation of a service card may be completed. To ensure that content of the service card can also be normally displayed subsequently even without network connection, or to save network resources, the rendering module 33 may further store the acquired resource file into an application cache. In this way, the mobile terminal can directly acquire the resource file of the service card from the application cache during restart subsequently, without the need of acquiring the resource file from a server terminal once again.

In addition, after the mobile terminal receives the URL from the management server 20, if a resource file corresponding to the URL has been stored into the application cache, the rendering module may also directly acquire the resource file corresponding to the URL from the application cache. The rendering module may then render the resource file to the view corresponding to the service card. However, there may be exceptions. For example, when the content of the service card is updated, that is, when the provider proposes updating the content of the service card, the provider server 10 may send a content update message to the management server 20. The content update message may include the URL corresponding to the service card. The management server 20 may send the content update message to the service management module 31 of the mobile terminal, which may then provide the content update message for the desktop module 32. The desktop module 32 may provide the content update message for the rendering module 33. The rendering module 33, after receiving the content update message, needs to re-acquire an HTML file corresponding to the URL, and then render the HTML file to the view corresponding to the service card.

In some embodiments, as previously mentioned, an application cache may be used. The application cache is a cache concept introduced by HTML5. The application cache can be used to cache web files, so that the web files are also accessible even if there is no Internet connection. At present, mainstream web engines generally can support the application cache. In the present disclosure, the resource file acquired by the rendering module 33 may be stored into the application cache. In the application cache, each resource file may be identified by a URL corresponding thereto. According to the HTML5 standard, if an application cache list included in the URL from the server terminal changes, it indicates that the resource file corresponding to the URL needs to be updated. For example, the application cache list included in the URL received by the mobile terminal may not be consistent with an application cache list locally stored. In this case, it is necessary to acquire a resource file corresponding to the URL from the server terminal, to update the resource file corresponding to the URL stored into the application cache. The application cache list may be actually a list of resource files, which need to be cached. These resource files may be associated with the URL.

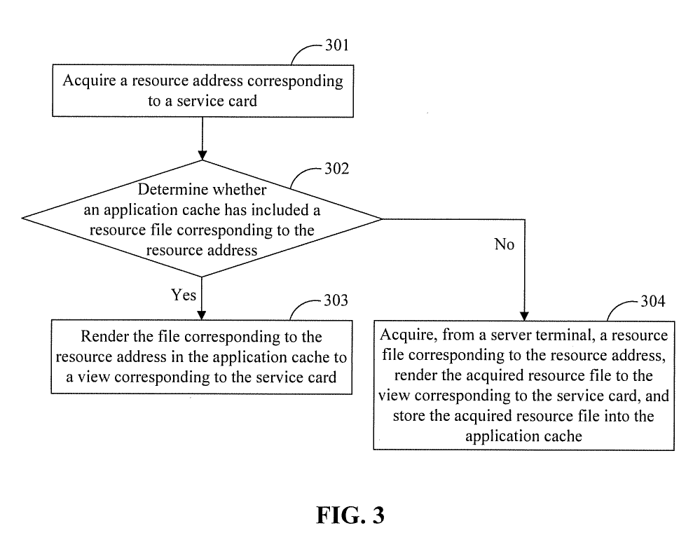

For the mobile terminal, an example process of creating a new card service may be as shown in FIG. 3, and can include, among others, the following steps:

In 301, a resource address corresponding to a service card is acquired.

In this step, after a resource address from a server terminal is received, an available view area is created on a desktop, if a service card corresponding to the resource address has not yet existed. The view area may be used to display the service card corresponding to the resource address. A view corresponding to the service card may be created in the view area.

In 302, it is determined whether an application cache includes a resource file corresponding to the resource address. If it is determined that the application cache includes a resource file corresponding to the resource address, in step 303, the file corresponding to the resource address in the application cache is rendered to the view corresponding to the service card.

On the other hand, if it is determined that the application cache does not include a resource file corresponding to the resource address, in step 304, the resource file corresponding to the resource address is acquired from the server terminal. The acquired resource file may then be rendered to the view corresponding to the service card, and the acquired resource file is stored into the application cache.

Based on the above process, after an operational event of a user on the service card is captured:

If it is determined that the application cache includes a resource file corresponding to the resource address requested by the operational event, the resource file corresponding to the resource address requested by the operational event is rendered to a view corresponding to the service card;

Otherwise, the resource file corresponding to the resource address requested by the operational event is acquired from the server terminal, the acquired resource file is rendered to the view corresponding to the service card, and the acquired resource file is stored into the application cache.

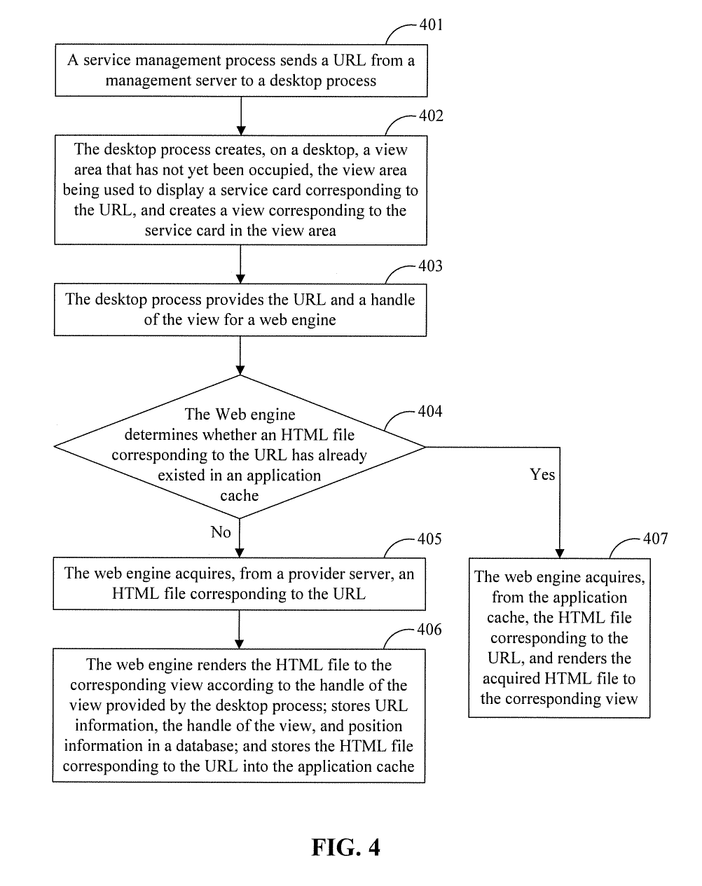

When the system architecture shown in FIG. 1 is employed to implement the above process of creating a new card service, the process thereof may be as shown in FIG. 4. In the embodiments shown in FIG. 4, the service management module and the desktop module are implemented by means of processes; the rendering module is implemented by means of a web engine. The following steps may be included in the process:

In step 401, a service management process sends a URL from a management server to a desktop process.

In step 402, the desktop process creates, on a desktop, a view area that has not yet been occupied, the view area being used to display a service card corresponding to the URL; and creates a view corresponding to the service card in the view area.

Herein, after the desktop process receives the URL from the management server (step 401), whether a service card corresponding to the URL has already existed on the desktop may be determined. If the service card has not yet existed, step 402 is performed. If the service card corresponding to the URL has already existed, it is unnecessary to create a view area, and a handle of a view of the service card corresponding to the URL and the URL may be directly sent to a web engine, and then step 404 is performed. Such a situation is not shown in FIG. 4.

In step 403, the desktop process provides the URL and the handle of the view for the web engine.

In step 404, the web engine determines whether an HTML file corresponding to the URL has already existed in an application cache. If the HTML file corresponding to the URL has not yet existed in the application cache, step 405 is performed. If the HTML corresponding to the URL has already existed in the application cache, step 407 is performed.

In step 405, the web engine acquires, from a provider server, an HTML file corresponding to the URL.

In step 406, the web engine renders the HTML file to the corresponding view according to the handle of the view provided by the desktop process. The web engine stores URL information, the handle of the view, and position information in a database; and stores the HTML file corresponding to the URL into the application cache. The current process may thus end.

In step 407, the web engine acquires, from the application cache, the HTML file corresponding to the URL, and renders the acquired HTML file to the corresponding view.

In the rendering process, the web engine may also return state information of the rendering process to the desktop process.

In the above process, the service management process, the desktop process, and the web engine may exchange information in a manner of inter-process communication. The manner of inter-process communication may include, but is not limited to, a broadcast manner, a file mapping manner, a memory sharing manner, a dynamic link library sharing manner, and the like. That is to say: the service management process may send the URL to the desktop process by means of inter-process communication; the desktop process may provide the URL and the handle of the view for the web engine by means of inter-process communication; and the web engine may return rendering state information by means of inter-process communication.

It can be seen from the above process that the embodiments of the present disclosure, by means of rendering, no longer relies on any template. Rather, the embodiments of the present disclosure can implement loading and display of resource content in any form, without the need to store multiple templates, thus reducing consumption of network resources. In addition, acquisition and rendering of a resource file are no longer performed by the desktop process but are performed by another process, i.e., the web engine. The rendering of the service card would not affect the desktop process, and would not bring about burden to the desktop process either, thereby reducing network consumption and improving stability.

In addition, the mobile terminal does not need to be installed with any specific application, and a resource file pushed by the provider server can be directly seen on the desktop, thus saving operational costs of a user and enhancing user experience. Moreover, if the HTML file corresponding to the URL has already existed in the application cache, the rendering module does not need to request and acquire the HTML file from the server terminal, thus saving network resources.

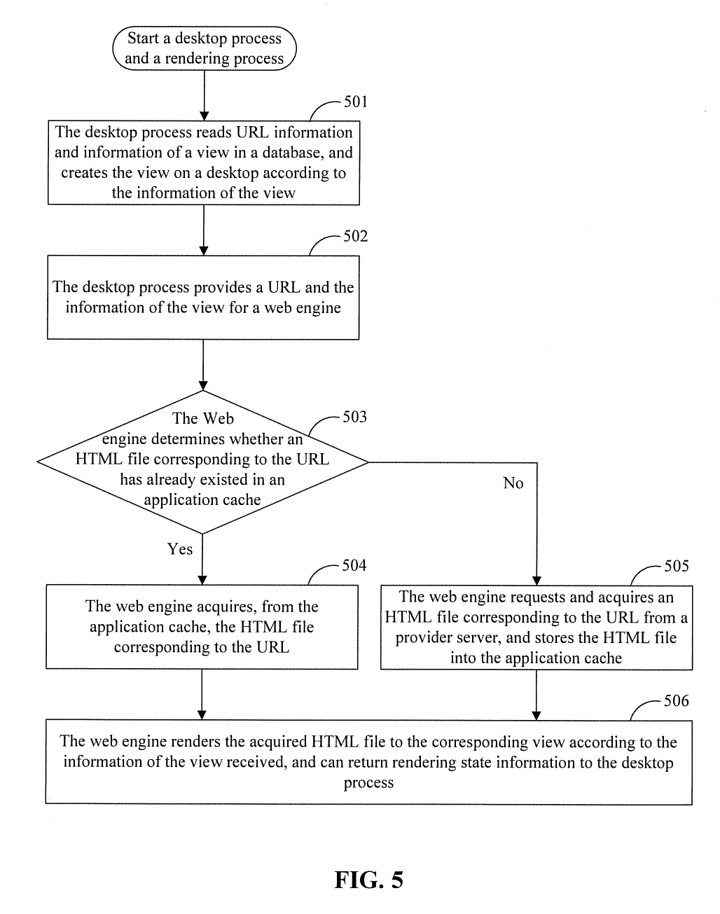

Referring back to FIG. 2, if the mobile terminal 30 is restarted, the desktop module 32 may directly display the service card by reading the URL and the information of the view in the database as well as the HTML file in the application cache. The specific process flow may be as shown in FIG. 5, and may include the following steps:

In step 501, after startup of the desktop process and the rendering process, the desktop process reads the URL information and the information of the view in the database, and creates a view on the desktop according to the information of the view.

As the information of the view includes the handle of the view and position information of the view, according to the position information of the view and the preset layout manner of a card-type desktop, the desktop process creates a view area, and creates a view in the view area.

In step 502, the desktop process provides the URL and the information of the view for the web engine.

In step 503, the web engine determines whether an HTML file corresponding to the URL has already existed in an application cache. If the HTML file corresponding to the URL has already existed in the application cache, in step 504, the web engine acquires, from the application cache, the HTML file corresponding to the URL, and step 506 is performed.

Otherwise, if the HTML file corresponding to the URL has not yet existed in an application cache, in step 505, the web engine requests and acquires, from the provider server, an HTML file corresponding to the URL, and stores the HTML file into the application cache. After step 505 is performed, the method proceeds to step 506.

In step 506, the web engine renders the acquired HTML file to the corresponding view according to the information of the view received, and can return rendering state information to the desktop process.

Through the above example process, when the mobile terminal starts, the card-type desktop may be displayed automatically, and the HTML file stored into the application cache may be directly used for rendering, thus saving network resources. Moreover, the service card may also be displayed normally even if there is no network, thus enhancing user experience.

The service card on the desktop may be resident on the desktop, and provide a user-oriented UI interface. The user may perform an operation on the service card and interact with the service card through the UI interface. Referring back to FIG. 2, when the user performs an operation on the service card, the rendering module 33 ora JavaScript code on the service card may capture the operation on the service card, and thus directly responds to the operation and/or reports the operation to the desktop module 32. The desktop module 32 may then respond to the operation.

Under many circumstances, the interaction of the user with the service card through the user interface is a request for a new resource file. For example, the user, by clicking a link in the resource file on the service card, requests a resource file corresponding to the link. For another example, the view corresponding to the service card, due to a limited display area, usually only displays some contents of a whole page. For other contents, it is necessary for the user to slide and click a button of “display the remaining page content,” or slide a slider to request for the remaining resource files not displayed. No matter which manner is employed, once the user triggers an event of requesting a new resource file, the JavaScript code of the service card or the rendering module 33 captures the event. If the JavaScript code captures the event, the rendering module 33 or the desktop module 32 may be notified.

When the rendering module 33 acquires the event triggered by the user, if the event is within the response permission of the rendering module 33, the rendering module 33 directly acquires a new resource file according to the event, and renders the new resource file to the corresponding view.

Herein, the rendering module 33, when acquiring the new resource file, may also first determine whether a resource file corresponding to a URL requested by the event has already existed in the application cache. If the resource file has already existed, the rendering module 33 acquires the resource file from the application cache and performs rendering. If the resource file has not existed, the rendering module 33 acquires, from the server terminal, the resource file corresponding to the URL requested by the event and performs rendering, and stores the resource file acquired from the server terminal into the application cache. That is to say, many URLs may be expanded from one service card, for a URL request derived from the user's operation on the service card, in some embodiments of the present disclosure, the application cache may be identified by using the service card. A URL corresponding to the service card and a resource file corresponding to a URL requested by an operational event on the service card may both be stored into the application cache. Subsequently, if the user performs an operation on the service card, and if the URL requested by the operational event has been requested before, a resource file corresponding to the URL may usually exist in the application cache. It is thus feasible to directly use the resource file in the application cache for rendering.

When the rendering module 33 acquires the event triggered by the user, if the event is beyond the response permission of the rendering module 33, the event may be reported to the desktop module 32. The desktop module 32, if determining that it is an event of acquiring a new resource file, provides address information of the new resource file and information of the corresponding view for the rendering module 33. The rendering module 33, after acquiring the new resource file, renders the new resource file to the corresponding view. In addition, in this case, the desktop module 32, if determining that it is an event of acquiring content of a new resource, may also newly create a window, and provide address information of the new resource file and corresponding window information for the rendering module 33. The rendering module 33, after acquiring the new resource file, renders the new resource file to the newly created window.

Similarly, the rendering module 33, when acquiring the new resource file, may also first determine whether a resource file corresponding to a URL requested by the event has already existed in the application cache. If the resource file has already existed, the rendering module 33 acquires the resource file from the application cache and performs rendering. If the resource file has not existed, the rendering module 33 acquires, from the server terminal, the resource file corresponding to the URL requested by the event and performs rendering, and stores the resource file acquired from the server terminal into the application cache.

If the JavaScript code notifies the desktop module 32 of the captured event, the desktop module 32 may send the address of the new resource file and the information of the view to the rendering module 33. The rendering module 33, after acquiring the new resource file, renders the new resource file to the corresponding view. Alternatively, the desktop module 32 may newly create a window, and sends the address of the new resource file and information of the newly created window to the rendering module 33. The rendering module 33, after acquiring the new resource file, renders the new resource file to the newly created window.

Similarly, the rendering module 33, when acquiring the new resource file, may also first determine whether a resource file corresponding to a URL requested by the event has already existed in the application cache. If the resource file has already existed, the rendering module 33 acquires the resource file from the application cache and performs rendering. If the resource file has not existed, the rendering module 33 acquires, from the server terminal, the resource file corresponding to the URL requested by the event and performs rendering, and stores the resource file acquired from the server terminal into the application cache.

The desktop module 32, when newly creating a window, may use various manners. For example, the desktop module 32 may newly create a large window, and the position of the window may cover all or part of the view on the card-type desktop. For another example, the window may be in a fixed area of the desktop, and the fixed area may not conflict with the view on the card-type desktop.

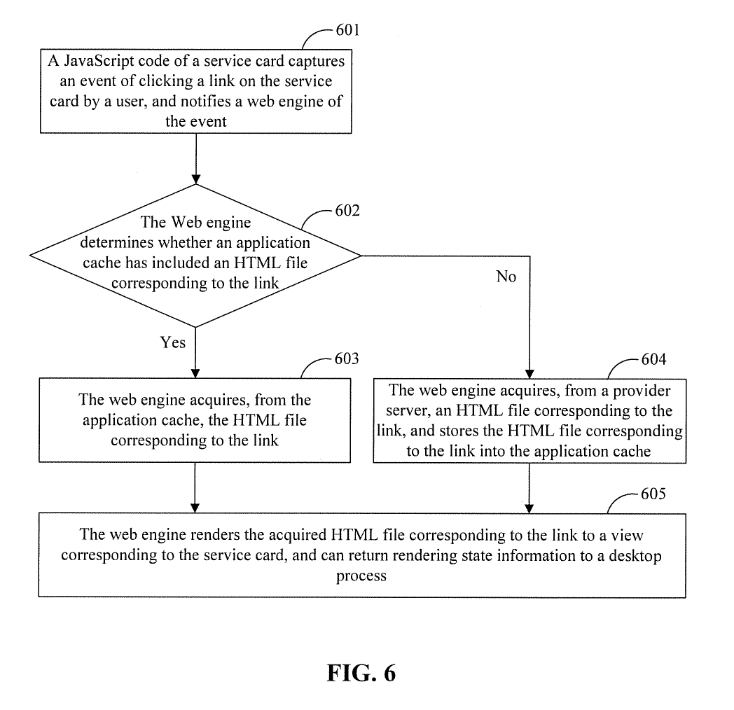

When the user interacts with the service card through the UI interface provided by the service card, the mobile terminal may perform the process flow as shown in FIG. 6. In these embodiments, as an example, it is assumed that a the user clicks a link on the service card and the web engine has response permission. The following steps may be included:

In step 601, a JavaScript code of the service card captures an event of clicking a link on the service card by the user, and notifies the web engine of the event.

In this step, it is also possible that an event processing module in the web engine directly captures an event of clicking a link on the service card by the user.

In step 602, the web engine determines whether an application cache has included an HTML file corresponding to the link. If the application cache has included an HTML file corresponding to the link, in step 603, the web engine acquires, from the application cache, the HTML file corresponding to the link, and step 605 is performed.

Otherwise, if the application cache has not included an HTML file corresponding to the link, in step 604, the web engine acquires, from the provider server, an HTML file corresponding to the link, and stores the HTML file corresponding to the link into the application cache. Step 605 may then be performed.

In step 605, the web engine renders the acquired HTML file corresponding to the link to a view corresponding to the service card, and may return rendering state information to the desktop process.

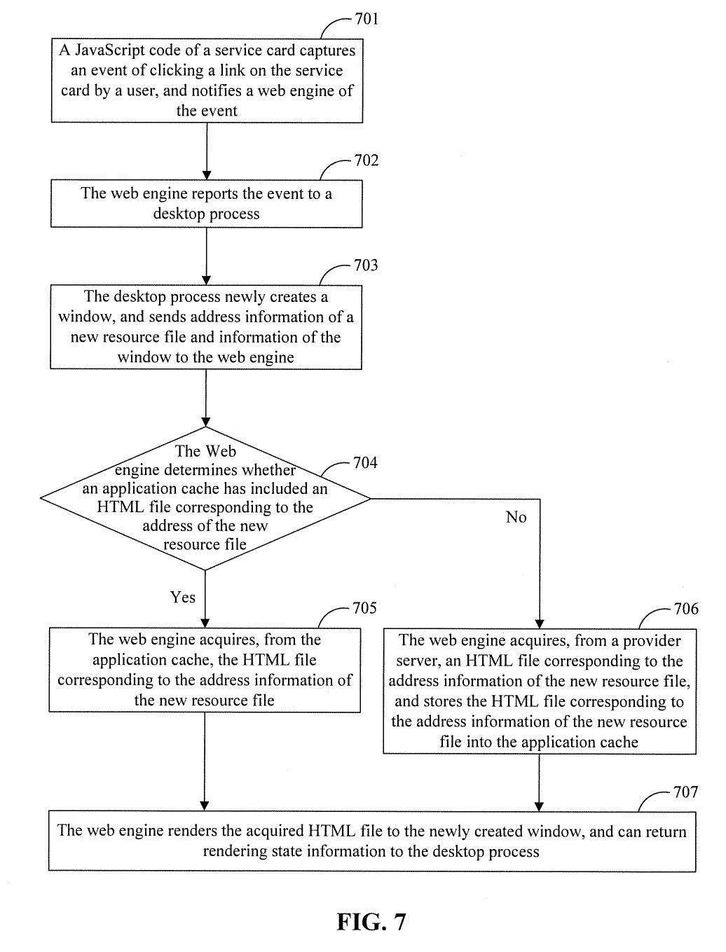

When the user interacts with the service card through the UI interface provided by the service card, the mobile terminal may also perform the process flow as shown in FIG. 7. In these embodiments, as an example, it is assumed that the user slides the service card and the web engine does not have response permission. The following steps may be included:

In step 701, a JavaScript code of the service card captures an event of sliding the service card by the user, and notifies the web engine of the event.

In this step, it is also possible that an event processing module in the web engine directly captures an event of sliding the service card by the user.

In step 702, the web engine reports the event to the desktop process.

In addition, it is also possible that the JavaScript code of the service card directly reports the event to the desktop process.

In step 703, the desktop process newly creates a window, and sends address information of a new resource file and information of the window to the web engine.

In step 704, the web engine determines whether the application cache has included an HTML file corresponding to the new resource file. If the application cache has included an HTML file corresponding to the new resource file, in step 705, the web engine acquires, from the application cache, the HTML file corresponding to the address information of the new resource file, and step 707 is performed..

Otherwise, if the application cache has not included an HTML file corresponding to the new resource file, in step 706, the web engine acquires, from the provider server, an HTML file corresponding to the address information of the new resource file, and stores the HTML file corresponding to the address information of the new resource file into the application cache. Step 707 may then be performed.

In step 707, the web engine renders the acquired HTML file to the newly created window, and can return rendering state information to the desktop process.

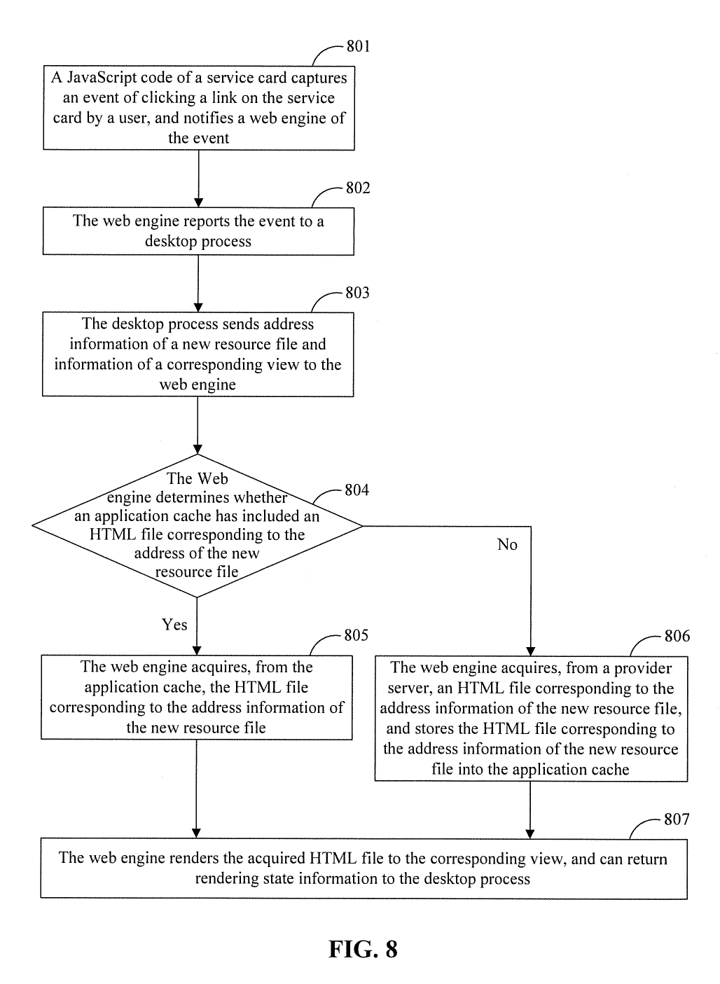

When the user interacts with the service card through the UI interface provided by the service card, the mobile terminal may also perform the process flow as shown in FIG. 8. In these embodiments, as an example, it is assumed that the user slides the service card and the web engine does not have response permission. The following steps may be included:

In step 801, a JavaScript code of the service card captures an event of sliding the service card by the user, and notifies the web engine of the event.

In this step, it is also possible that an event processing module in the web engine directly captures an event of sliding the service card by the user.

In step 802, the web engine reports the event to the desktop process.

In addition, it is also possible that the JavaScript code of the service card directly reports the event to the desktop process.

In step 803, the desktop process sends address information of a new resource file and information of the corresponding view to the web engine.

In step 804, the web engine determines whether the application cache has included an HTML file corresponding to the address information of the new resource file. If the application cache has included an HTML file corresponding to the new resource file, in step 805, the web engine acquires, from the application cache, the HTML file corresponding to the address information of the new resource file. Step 807 may then be performed.

Otherwise, if the application cache has not included an HTML file corresponding to the new resource file, in step 806, the web engine acquires, from the provider server, an HTML file corresponding to the address information of the new resource file, and stores the HTML file corresponding to the address information of the new resource file into the application cache. Step 807 may then be performed.

In step 807, the web engine renders the acquired HTML file to the corresponding view, and can return rendering state information to the desktop process.

These embodiments are different from the embodiments shown in FIG. 7 in that after the user clicks a link, a resource file corresponding to the link is still displayed in the original view. In contrast, the embodiments shown in FIG. 7 display the resource file through a new window.

In the above process shown in FIG. 7, the desktop process may newly create a window according to a preset window size and position information.

In addition, in the above process shown in FIG. 7, if the JavaScript code directly reports the event to the desktop process, the JavaScript code, when reporting the event, may report the window size and/or the position information to the desktop process. The desktop process may newly create a window according to the received window size and/or position information. In this manner, the JavaScript code may determine a window size and/or position suitable for displaying the HTML file according to at least one piece of the reported information, such as the size of the HTML file corresponding to the link, and the size and resolution of the screen of the mobile terminal, and the like. How the window size and/or position are/is specifically determined is not limited in the embodiments of the present disclosure.

It can be seen from the example processes shown in FIG. 6 to FIG. 8 that the user, on the card-type desktop, may interact with the service card through the UI interface provided by the service card, and acquire more service contents, thereby further improving user experience. In addition, a variety of implementations such as displaying in the original view and displaying in a newly created window are further provided. The implementations are flexible and may be in various manners. Moreover, if an HTML file requested by an operational event of a user has already existed in the application cache, the HTML file requested by the operational event of a user in the application cache may be rendered. This, on the one hand, may respond to an operation of the user in the case of no network; and on the other hand, has a faster response speed compared with the manner of network acquisition.

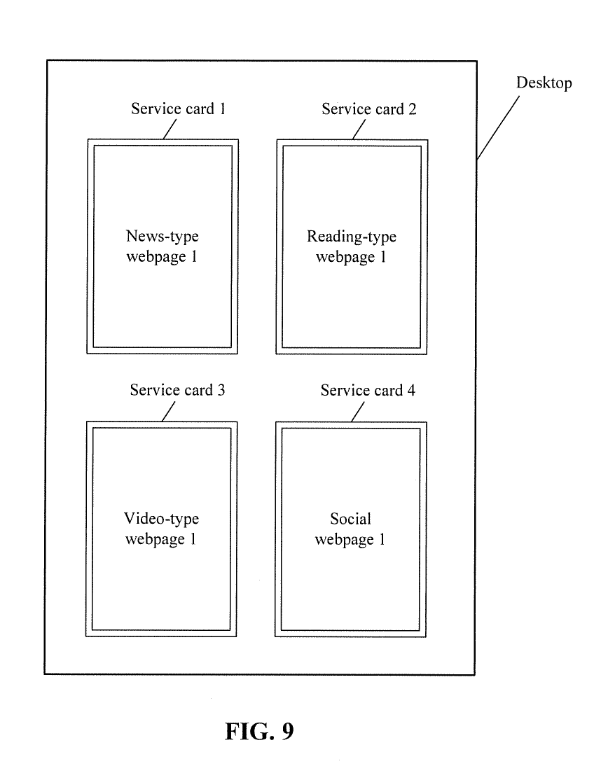

As an example of the effect, if a user subscribes to a news-type service card, a reading-type service card, a video-type service card, and a social service card, through the example processes shown in FIG. 3 or FIG. 4, the desktop card as shown in FIG. 9 may be implemented on the desktop. The desktop card may include four service cards, and the four service cards are respectively “news-type webpage 1,” “reading-type webpage 1,” “video-type webpage 1,” and “social webpage 1,” provided by a provider.

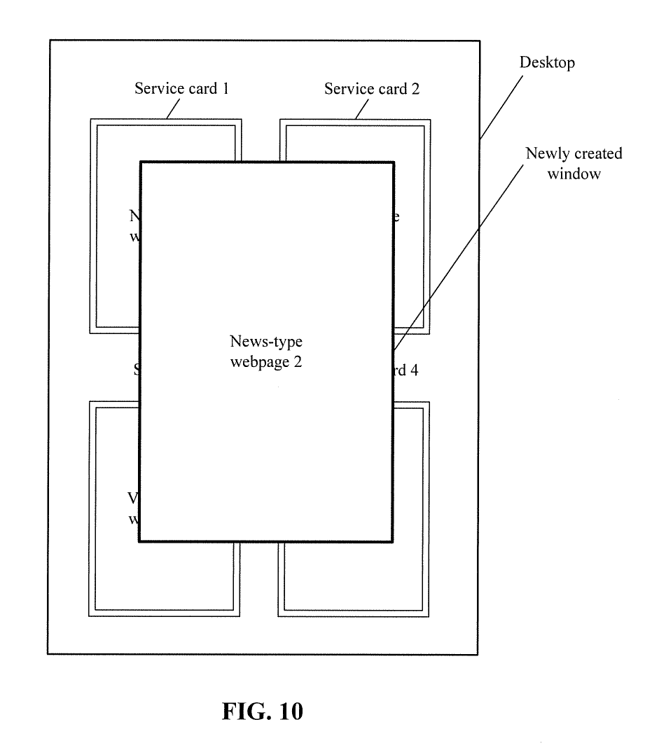

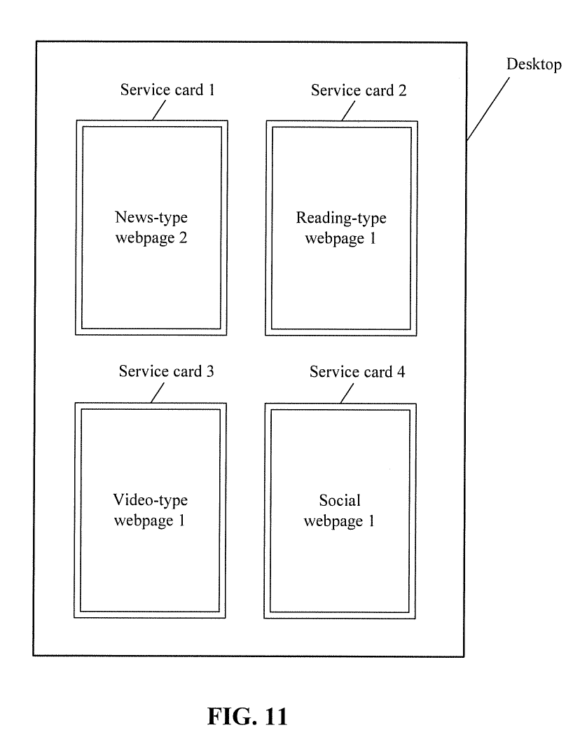

Referring to the card-type desktop shown in FIG. 9, suppose that the user clicks on a link of a particular piece of news in the “news-type webpage 1,” the example process as shown in FIG. 7 may be performed to display a “news-type webpage 2” corresponding to the link in a newly created window, as shown in FIG. 10. Execution may also be performed according to the example processes shown in FIG. 6 or FIG. 8, to display a “news-type webpage 2” corresponding to the link in the original view, as shown in FIG. 11.

As increasingly more resource files are cached in the application cache through long-time caching, which affects system performance, a mechanism of deleting the resource files in the application cache may be desired. For example, the number of resource files corresponding to a service card in the application cache may exceed a preset number threshold. In that case, it is possible to delete, from the application cache, resource files corresponding to URLs which are not accessed within a preset time, among the URLs corresponding to the service card. For example, suppose that the number of HTML files corresponding to a service card 1 in the application cache exceeds a preset number threshold, URLs which are not accessed within a preset time may be determined, among URLs corresponding to the service card 1. HTML files corresponding to the determined URLs may be deleted from the application cache.

When the resource files are deleted from the application cache, it is possible that the rendering module 33 or the desktop module 32 directly deletes the resource files from the application cache. However, to better incorporate the existing application cache mechanism of HTML5, the following deletion manner may be adopted:

When the rendering module 33 determines to delete an HTML file corresponding to a URL, a request carrying indication information of deleting a resource file is sent to the provider server 10 by using the URL. For example, the indication information may be carried through a cookie in a request, with the purpose of telling the provider server 10 to clear up an application cache corresponding to the URL. The provider server 10, after receiving the request, returns a response, wherein an application cache list carried in the response may be empty. In order to reduce system consumption as much as possible, the response may include an HTML file as simple as possible. The rendering module 33, after receiving a response specific to the URL, analyzes the response. If the application cache list is empty, the rendering module 33 may clear up a resource file corresponding to the URL in the application cache.

In the several embodiments provided in the present disclosure, it should be appreciated that the disclosed apparatus and methods may be implemented in other manners. The described apparatus and methods embodiments are only exemplary. For example, division of the units may be merely division of logical functions, and division in other manners may exist in actual implementation.

Further, the units described as separate parts may or may not be physically separate, and parts displayed as units may or may not be physical units. They may be located at one place, or may be distributed on a plurality of network units. Some or all of the units may be selected according to actual needs to achieve the objectives of the solutions of the embodiments.

In addition, functional units in the embodiments of the present disclosure may be integrated into one processing unit, or each of the units may exist separately physically, or two or more units may be integrated into one unit. The integrated units may be implemented in a form of hardware, or may be implemented in a form of a hardware plus software functional unit.

The integrated units implemented in the form of software functional units may be stored in a computer-readable storage medium. A software functional unit may be stored in a storage medium, which may include several instructions for instructing a computer device (which may be a personal computer, a server, a network device, or the like) or a processor to perform a part of the steps of the methods described in the embodiments of the present disclosure. The foregoing storage medium may include: any medium that can store a program code, such as a USB flash disk, a removable hard disk, a Read-Only Memory (ROM), a Random Access Memory (RAM), a magnetic disk, or an optical disc.

The foregoing are only some example embodiments of the present disclosure, which are not used to limit the invention. Any modification, equivalent replacement, improvement, and the like made within the spirit and principle of the invention are all encompassed in the protection scope of the invention.

1-11. (canceled)

12. A card-type desktop implementation apparatus, comprising:
a memory storing a set of instructions; and
a processor configured to execute the instructions to cause the card-type desktop implementation apparatus to:
acquire, a first resource address corresponding to a service card; and
render, a first resource file to a view corresponding to the service card,
wherein the first resource file corresponds with the first resource address and is acquired from either an application cache that includes the first resource file or a server terminal in response to the application cache not including the first resource file.

13. The apparatus according to claim 12, wherein the processor is further configured to cause the card-type desktop implementation apparatus to:
create, an available view area on a desktop, the view area being used to display the service card; and
create the view corresponding to the service card in the view area.

14. The apparatus according to claim 12, wherein the processor is further configured to cause the card-type desktop implementation apparatus to:
if the service card has already existed on the desktop, render the first resource file to the view based on view information corresponding to the service card.

15. The apparatus according to claim 12, wherein the processor is further configured to cause the card-type desktop implementation apparatus to:
read, related information of the service card in a database, the related information of the service card comprising view information corresponding to the service card; and
create the view on a desktop according to the view information.

16. The apparatus according to claim 12, wherein the processor is further configured to cause the card-type desktop implementation apparatus to:
acquire an operational event of a user on the service card; and
acquire a second resource address requested by the operational event.

17. The apparatus according to claim 16, wherein the operational event is captured by a JavaScript code on the serve card.

18. The apparatus according to claim 12, wherein the processor is further configured to cause the card-type desktop implementation apparatus to:
render, a second resource file to the view,
wherein the second resource file corresponds with a second resource address requested by an operation event of a user, and is acquired from either the application cache if the application cache includes the second resource file, or the server teiiiiinal in response to the application cache not including the resource file.

19. The apparatus according to claim 12, wherein the processor is further configured to cause the card-type desktop implementation apparatus to:
delete resource files corresponding to resource addresses not accessed within a preset time, from the application cache, if the number of resource files corresponding to the service card in the application cache exceeds a preset number threshold.

20. The apparatus according to claim 19, wherein the processor is further configured to cause the card-type desktop implementation apparatus to:
send a request to the server terminal by using the resource addresses, the request carrying indication information of deleting a resource file;
analyze a response returned by the server terminal; and
delete, if an application cache list carried in the response is empty, the resource files corresponding to the resource addresses in the application cache.

21. The apparatus according to claim 17, wherein the processor is further configured to cause the card-type desktop implementation apparatus to:
after acquiring the operational event, create a window; and,
render, a second resource file corresponding to the second resource address to the window, according to acquired information of the window.

22. The apparatus according to claim 21, wherein the processor is further configured to cause the card-type desktop implementation apparatus to:
receive at least one of size information and position information of the window reported by the JavaScript code;
wherein the window is created based on the received information.

23. A card-type desktop implementation method, comprising:
acquiring a first resource address corresponding to a service card;
rendering, a first resource file to a view corresponding to the service card, wherein the first resource file corresponds with the first resource address and is acquired from either an application cache that includes the first resource file or a server terminal in response to the application cache not including the first resource file.

24. The method according to claim 23, further comprising:
creating, an available view area on a desktop, the view area being used to display the service card; and creating a view corresponding to the service card in the view area.

25. The method according to claim 23, wherein the method further comprises:
rendering, a second resource file to the view,
wherein the second resource file corresponds with a second resource address requested by an operation event of a user, and is acquired from either the application cache if the application cache includes the second resource file, or the server terminal in response to the application cache not including the second resource file.

26. The method according to claim 23, wherein the method further comprises:
deleting resource files corresponding to resource addresses not accessed within a preset time, from the application cache, if the number of resource files corresponding to the service card in the application cache exceeds a preset number threshold.

27. The method according to claim 26, further comprising:
sending a request to the server tenninal by using the resource addresses, the request carrying indication information of deleting a resource file;
analyzing a response returned by the server terminal; and
deleting, if an application cache list carried in the response is empty, the resource files corresponding to the resource addresses in the application cache.

28. The method according to claim 23, further comprising:
if the service card has already existed on the desktop, rendering the first resource file to the view, based on view information corresponding to the service card.

29. The method according to claim 23, further comprising:
reading related information of the service card in a database, the related information of the service card comprising view information corresponding to the service card; and
creating the view on a desktop according to the view information.

30. The method according to claim 23, further comprising:
acquiring an operational event of a user on the service card; and
acquiring a second resource address requested by the operational event.

31. The method according to claim 30, wherein the operational event is captured by a JavaScript code on the service card.

32. The method according to claim 31, further comprising:
creating a window, after acquiring the operational event; and
rendering, a second resource file corresponding to the second resource address to the window, according to acquired information of the window.

33. The method of claim 32, further comprising:
receiving at least one of size information and position information of the window reported by the JavaScript code; and
creating the window based on the received information.

34. A non-transitory computer readable medium that stores a set of instructions, which are executable by at least one processor of a card-type desktop implementation apparatus to perfoiui a card-type desktop implementation method, the method comprising:
acquiring a resource address corresponding to a service card;
rendering, a resource file to a view corresponding to the service card, wherein the resource file corresponds with the resource address and is acquired from either an application cache that includes the resource file or a server terminal in response to the application cache not including the resource file.

35. A card-type desktop implementation apparatus, comprising:
a desktop module, configured to:
acquire, a resource address corresponding to a service card; and
a rendering module, configured to:
render, a resource file to a view corresponding to the service card, wherein the resource file corresponds with the resource address and is acquired from either an application cache that includes the resource file or a server terminal in response to the application cache not including the resource file.
